(19) United States
(12) Patent Application Publication
(10) Pub. No.: US 2021/0403667 A1
(43) Pub. Date: Dec. 30, 2021

(54) AZEOTROPICALLY-MODIFIED BLOWING AGENTS FOR FORMING FOAMS

(71) Applicant: INVISTA NORTH AMERICA S.A R.L., Wilmington, DE (US)

(72) Inventor: Carina MCADAMS, Wilmington, DE (US)

(73) Assignee: INV Performance Surfaces, LLC, Kennesaw, GA (US)

(21) Appl. No.: 17/293,690

(22) PCT Filed: Nov. 7, 2019
(86) PCT No.: PCT/IB2019/059563

§ 371 Date: May 13, 2021

Related U.S. Application Data
(60) Provisional application No. 62/760,288, filed on Nov. 13, 2018.

(51) Int. Cl. C08J 9/14; C08J 9/12; C08G 18/42

(52) U.S. Cl. CPC C08J 9/149; C08G 2110/0025; C08J 9/142; C08J 9/146; C08J 9/125; C08J 9/127; C08G 18/42; C08J 2201/022; C08J 2203/202; C08J 2203/182; C08J 2203/14; C08J 2203/12; C08J 2203/162; C08J 2203/10; C08J 2205/10; C08J 2375/06; C08J 9/141

(57) ABSTRACT

The present disclosure relates to improving insulation properties of foams by employing an azeotropically-modified blowing agent that preserves or improves R-value at various temperatures such as lower than ambient temperatures (below 24° C.). The present disclosure also provides foams with improved long-term thermal resistance (LTTR).

### CROSS-REFERENCE TO RELATED APPLICATION

This application claims the benefit of priority to U.S. Provisional Patent Application Ser. No. 62/760,288 filed Nov. 13, 2018, the disclosure of which is incorporated herein in its entirety by reference.

### BACKGROUND

Polyurethane (PUR) and polyisocyanurate (PIR) cellular foams have been among the most widely used and versatile insulating materials for many applications, such as insulation of cooling and heating appliances, pour-in-place door panels, construction insulation, lamination of insulation panels, spray foam insulation, structural foams for housing, wood lamination, packaging, and the like.

PUR/PIR foams are formed by reacting an organic isocyanate with a polyether polyol, a polyester polyol, or a combination thereof, in the presence of a blowing agent. Aromatic polyester polyols (herein referred to as APPs) have been in the PUR/PIR industry for the past five decades and play a role in various PUR/PIR rigid foam applications, including PUR spray foam systems. Industrial uses of APPs include manufacture of PUR and/or PIR polymer products. The PUR and PIR polymers are polyfunctional and can be used as adhesives, binders (e.g., for wood fibers), coatings, and foams. The known benefits include low-cost, rigid cellular structure, and excellent properties that are desired for many end-use applications.

In the rigid foam insulation industry that uses PIR/PUR foams, manufacture of rigid foams with fine cellular structure is desirable to give improved insulation properties (e.g., improved R-value). In reacting the A-side component (organic isocyanates) with the B-side component (polyol resin) in the presence of a blowing agent, a good balance of foaming versus unique cellular structures with well-formed cell boundaries is required. Proper choice of surfactant during the reaction of A-side and B-side is needed to develop acceptable cell structure and reduced defects. Problems that can occur include elongated cells and collapsed cellular structures, which can adversely affect the structural, mechanical strength and insulation properties of the final foam structure especially in systems using hydrocarbon blowing agents.

Hydrocarbon blowing agents including C₅-hydrocarbons can include n-pentane, iso-pentane, cyclopentane, and blends thereof. During the foam blowing process involving isocyanates (A-side component) and polyols emulsion (B-side component), C₅-hydrocarbon blowing agents must sufficiently homogenize and compatibilize in the reactive AB emulsion matrix. This is important in order to uniformly disperse the blowing agent such that a stable, well-formed, and fine cellular substance with round cell structures can be formed. Such fine well-rounded cellular structures have desirable foam properties such as dimensional stability, mechanical strength, processing ease, and insulation performance.

In PUR/PIR foam industry, R-value (a measure of thermal resistivity) is an important performance indicator. The higher the R-value (or the lower the thermal conductivity), the better the insulation performance of the foam.

Thermal insulation products such as foams, sheets, and the like, that have superior insulation, mechanical, and dimensional properties while preserving the R-value performance at lower than ambient temperatures (e.g., below 75° F.) are desirable. Also, foams with better long-term thermal resistance are sought for in the insulation industry. Better thermal insulation properties, especially at very low temperatures such as during the winter season, are attractive due to energy efficiency, energy conservation, minimizing the cost of the insulation needed to achieve a certain insulation performance, and due to the improved overall comfort provided.

### SUMMARY OF THE INVENTION

In various embodiments, the present disclosure provides a blowing agent composition for a foam precursor. The foam precursor forms (i.e., reacts to form) a foam composition. The blowing agent composition includes a blowing agent (e.g., one or more blowing agents) that is 80 wt % to 95 wt % of the blowing agent composition (e.g., the one or more blowing agents are 80 wt % to 95 wt % of the blowing agent composition). The blowing agent composition includes one or more azeotropic-modifiers that lower the boiling point of the blowing agent composition (e.g., relative to the same composition without the one or more azeotropic-modifiers). The one or more azeotropic-modifiers are 5 wt % to 20 wt % of the blowing agent composition.

In various embodiments, the present disclosure provides a B-side of a foam precursor including an A-side and the B-side, wherein the foam precursor forms a foam composition. The B-side of the foam precursor includes a blowing agent composition that includes a blowing agent that is 80 wt % to 95 wt % of the blowing agent composition. The blowing agent composition includes one or more azeotropic-modifiers that lower the boiling point of the blowing agent composition. The one or more azeotropic-modifiers are 5 wt % to 20 wt % of the blowing agent composition. The B-side of the foam precursor includes polyol for reacting with one or more organic isocyanates included in the A-side to form the foam precursor. The B-side of the foam precursor includes catalyst for catalyzing the formation of the foam composition from the foam precursor. The B-side of the foam precursor also includes surfactant.

In various embodiments, the present disclosure provides a foam precursor that forms a foam composition. The foam precursor includes an A-side including one or more organic isocyanates. The foam precursor also includes a B-side. The B-side of the foam precursor includes a blowing agent composition that includes a blowing agent that is 80 wt % to 95 wt % of the blowing agent composition. The blowing agent composition includes one or more azeotropic-modifiers that lower the boiling point of the blowing agent composition. The one or more azeotropic-modifiers are 5 wt % to 20 wt % of the blowing agent composition. The B-side of the foam precursor includes polyol for reacting with one or more organic isocyanates included in the A-side to form the foam precursor. The B-side of the foam precursor includes catalyst for catalyzing the formation of the foam composition from the foam precursor. The B-side of the foam precursor also includes surfactant. The one or more azeotropic-modifiers are less than 1 wt % of the foam composition.

In various embodiments, the present disclosure provides a foam composition formed from a foam precursor. The foam precursor includes an A-side including one or more organic isocyanates. The foam precursor also includes a B-side. The B-side of the foam precursor includes a blowing agent composition that includes a blowing agent that is 80 wt % to 95 wt % of the blowing agent composition. The blowing agent composition includes one or more azeotropic-modifiers that lower the boiling point of the blowing agent composition. The one or more azeotropic-modifiers are 5 wt % to 20 wt % of the blowing agent composition. The B-side of the foam precursor includes polyol for reacting with one or more organic isocyanates included in the A-side to form the foam precursor. The B-side of the foam precursor includes catalyst for catalyzing the formation of the foam composition from the foam precursor. The B-side of the foam precursor also includes surfactant. The one or more azeotropic-modifiers are less than 1 wt % of the foam composition.

In various embodiments, the present disclosure provides a method of forming a foam composition from the foam precursor described herein. The method includes reacting a foam precursor (e.g., allowing the foam precursor to react) to form the foam composition. The foam precursor includes an A-side including one or more organic isocyanates. The foam precursor also includes a B-side. The B-side of the foam precursor includes a blowing agent composition that includes a blowing agent that is 80 wt % to 95 wt % of the blowing agent composition. The blowing agent composition includes one or more azeotropic-modifiers that lower the boiling point of the blowing agent composition. The one or more azeotropic-modifiers are 5 wt % to 20 wt % of the blowing agent composition. The B-side of the foam precursor includes polyol for reacting with one or more organic isocyanates included in the A-side to form the foam precursor. The B-side of the foam precursor includes catalyst for catalyzing the formation of the foam composition from the foam precursor. The B-side of the foam precursor also includes surfactant. The one or more azeotropic-modifiers are less than 1 wt % of the foam composition.

### BRIEF DESCRIPTION OF THE FIGURES

The drawings illustrate generally, by way of example, but not by way of limitation, various embodiments of the present invention.

FIG. 1 is a graphical representation of an embodiment with and without adding methyl formate to iso-/n-pentane blowing agent system, and according to the Examples 1(a-b).

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the suitable methods and materials are now described. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 50%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

As used herein, the term “polymer” refers to a molecule having at least one repeating unit and can include copolymers.

All percent compositions are given as weight-percentages or wt %, unless otherwise stated. When solutions or mixtures of components are referred to, percentages refer to weight-percentages of the component relative to the total composition unless otherwise indicated.

All average molecular weights of polymers are weight-average molecular weights, unless otherwise specified.

As used herein, the terms “OH #”, “hydroxyl value” (abbreviated as HV), or “hydroxyl number” (abbreviated as HN) indicates the total amount of residual hydroxyl (—OH) groups present in the material. The OH #, HV or HN is reported as mg KOH/gm (i.e., milligrams of KOH per gram of sample) and is measured according to well-known methods such as standard ASTM D-1957, ASTM E-1899 or ASTM D-4274.

As used herein, the term “INDEX” means isocyanate index. The PUR/PIR foam can be produced at various volume ratios of polyol composition and polyisocyanate to obtain a certain isocyanate index. The isocyanate index is the actual amount of isocyanate used divided by the theoretical amount of isocyanate required, in terms of stoichiometric equivalents. The ratios are normally referred to as A:B where “A” (or A-side component) is the polyisocyanate and “B” (or B-side component) is the polyol composition. An index of 1:1 means that the same number of —NCO groups in the isocyanate (in the A-side) and —OH groups in the polyol (in the B-side) are used. In an embodiment, the ratio can be about 1:1 to 3:1. A non-limiting example is the INDEX of 2.5 or 2.6.

As used herein, the term “average functionality” or “average hydroxyl functionality” of a polyol indicates the number of —OH groups per molecule, on average. The average functionality of an isocyanate refers to the number of —NCO groups per molecule, on average. The functionality of a B-side foam ingredient is the number of isocyanate reactive sites on a molecule. For polyols, an average functionality is calculated as (total moles of —OH groups)/(total moles of polyol).

As used herein, the term “foam” refers to a cellular structure produced by an expansion process, known as “foaming”, and also having a comparatively low weight per unit volume (or density) and with low thermal conductivity. The cellular structure is made up of well-defined cell boundaries, wherein a low-density component (such as gas) is dispersed and confined within the cells distributed across a continuous phase (liquid or solid). Cellular foams can be light-weight or heavy, porous or dense, semi-rigid or rigid, or flexible spongy materials depending on the end-use application. Rigid foams are usually the solidified form of a continuous liquid matrix full of gas-filled cells or bubbles dispersed within the matrix. Rigid foams are often used as insulators for noise abatement, shock absorption and/or as heat insulators in construction, in cooling and heating technology (e.g., household appliances), for producing composite materials (e.g., sandwich elements for roofing and siding), and for wood simulation material, model-making material, and packaging.

Pressures reported as pounds per square inch gauge (psig) are relative to one atmosphere. One pound per square inch equals 6.895 kilopascals (kPa). One atmosphere is equivalent to 101.325 kPa or about 14.7 pounds per square inch absolute (psia) or about zero psig.

The problem of lower R-value for such foams (made using polyester and/or polyether polyols) may be solved by use of a new class of blowing agents [BA] that provide preservation of R-value at lower than ambient temperatures (e.g., below 75° F.).

The present disclosure may be applicable in the development of different kinds of foams with superior low-temperature R-values and long-term thermal resistance (LTTR) performance, such but not limited to, rigid foams, spray foams, rigid boards, insulation materials, and the like.

The present disclosure provides that blowing agents may be designed to include azeotrope-inducing modifiers. For example, lower alcohols (methanol, ethanol, IPA) may be introduced in the commonly used C₅-hydrocarbons (n-pentane, isopentane, cyclopentane). In other examples, alkyl esters of organic acids may be introduced in the blowing agent system, such as a methyl ester of formic acid (i.e., methyl formate or methyl methanoate). In some other examples, an ether such as dimethoxymethane, also called methylal, may be introduced in the blowing agent system. Adding a small amount may form azeotropes and could improve temperature dependent R-value (TDRV) behavior for the pentane-based blowing agent system.

In the present disclosure, it has been unexpectedly found that at low temperatures, for example, lower than the ambient temperatures of 75° F., including azeotrope-inducing modifiers in the blowing agent system brings superior insulation properties to the foams, such as better low temperature R-value preservation along with long-term thermal resistance (LTTR). As blowing agent condenses foam tends to lose its gas insulating properties and therefore the R-value suffers. Without being bound by the theory, the azeotrope-inducing modifier in the present blowing agent may not condense as much or as easily, having a lower boiling point versus that in the conventional systems.

Also, as the hydrocarbon content of the blowing agent is lowered, it can be desirable to maintain the blowing agent density which can be done by adding some water or other ingredients that are compatible with the overall system.

Table A lists the binary azeotropes for five-carbon hydrocarbons that can be used as blowing agents. The term “b.p.” means boiling point of a material.

TABLE A
Binary azeotropes for five-carbon hydrocarbons.

| | | | Azeotropic Mixture | |
|---|---|---|---|---|
| Component 1 | Component 2 | | Comp. 1:Comp. 2 | Mixture |
| b.p. (° C.) | Comp. 2 | b.p. (° C.) | (wt:wt) | b.p. (° C.) |
| N-pentane [36.2] | Methanol | 64.7 | 91:9 | 30.8 |
| | Methanol | 64.7 | 85:15 | 30.4 |
| | Ethanol | 78.4 | 95:5 | 34.3 |
| | Iso-propanol | 82.5 | 94:6 | 35.5 |
| | Formic acid | 100.7 | 90:10 | 34.2 |
| | Water | 100 | 98.6:1.4 | 34.6 |
| | Dimethyl sulfide | 37.3 | 49.7:50.3 (mole basis) | 31.8 |
| | Ethyl formate | 54.2 | 70:30 | 32.5 |
| | Diethyl ether | 34.6 | 45:55 (mole basis) | 33.8 |
| | Methyl propyl ether | 38.8 | 78.5:21.5 (mole basis) | 35.6 |
| | Carbon disulfide | 46.25 | 90:10 | 35.7 |
| | Acetone | 56.4 | 80:20 | 32.0 |
| | Propylene oxide | 35.0 | 43:57 | 27.5 |
| | Methyl formate | 31.9 | 47:53 | 21.8 |
| | Methyl sulfide | 37.2 | 55:45 | 33.5 |
| | Propyl nitrite | 47.8 | 89:11 | 35.9 |
| | Iso-propyl nitrite | 40.0 | 62:38 | 34.5 |
| | Methyl propyl ether | 38.8 | 75:25 | 35.3 |
| | diethylamine | 55.9 | 85:15 | 35.0 |
| | Methylal | 35.0 | 65:35 | 33.7 |
| Iso-pentane [30.0] | Methylal | 35.0 | 77:23 | 27.0 |
| | Methanol | 64.7 | 90.7:9.3 (mole basis) | 24.1 |
| | Ethanol | 78.4 | 94.6:5.4 (mole basis) | 27.0 |
| | Acetonitrile | 82.0 | 89.6:10.4 (mole basis) | 25.5 |
| | Methyl formate | 31.9 | 50.8:49.2 (mole basis) | 18.6 |
| | Acetone | 56.4 | 82.7:17.3 (mole basis) | 25.8 |
| | Iso-propanol | 82.5 | 86.3:13.7 (mole basis) | 25.2 |
| Cyclo-pentane [50.0] | Acetone | 56.4 | 59.6:40.4 (mole basis) | 41.0 |
| | Methylal | 35.0 | 38:62 | 40.0 |
| | Ethanol | 78.4 | 82:18 (mole basis) | 50.44 |

Table B below lists the ternary azeotropes for five-carbon hydrocarbons that can be used as blowing agents.

TABLE B
Ternary azeotropes for five-carbon hydrocarbons.

| Component 1 | | Component 2 | | Component 3 | | Ternary Azeotrope Mixture | |
|---|---|---|---|---|---|---|---|
| | b.p. | | b.p. | | b.p. | Comp 1:Comp 2: | Mixture |
| | (° C.) | | (° C.) | | (° C.) | Comp 3 | b.p. (° C.) |
| N- | 36.2 | Ethanol | 78.4 | Water | 100 | 4.9:5.2:89.9 | 34.1 |
| pentane | | | | | | (mole basis) | |
| N- | 36.2 | Ethanol | 78.4 | Acetone | 56.4 | 72.9:16.8:10.3 | 99.7 @ 688 kPa |
| pentane | | | | | | (mole basis) | pressure |

Table A and Table B data are compiled from the widely available public references: Lange's Handbook of Chemistry, 10th ed. pp 1496-1505; CRC Handbook of Chemistry and Physics, 44th ed. pp 2143-2184; Table of Azeotropes & Nonazeotropes, L. H. Horsley, The Dow Chemical Company; AZEOTROPIC DATA FOR BINARY MIXTURES, J. Gmehling et.al., 6-210.

Non-limiting examples of azeotropic mixtures for n-pentanes and isomers of n-pentanes useful in the present application may include any of the listed combinations from Table A or Table B. For example, n-pentane/methanol, n-pentane/ethanol, n-pentane/iso-propanol, n-pentane/methyl formate, n-pentane/methylal, iso-pentane/methanol, iso-pentane/ethanol, iso-pentane/methyl formate, iso-pentane/methylal, cyclopentane/acetone, cyclopentane/methylal, cyclopentane/ethanol, n-pentane/ethanol/water, n-pentane/ethanol/acetone, and other combinations and mixtures that may form azeotropic composition for blowing agent system. A skilled person in the field of chemicals industry understands the benefits and challenges of using azeotropic mixtures.

The compositions prepared in the present disclosure can further include one or more other components known to those skilled in the art and dependent on end use. Such components may include other polyols, solvents, catalysts, chain extenders, cross-linkers, curing agents, surfactants, blowing agents, fillers, flame retardants, plasticizers, light stabilizers, colorants, waxes, biocides, minerals, micronutrients, inhibitors, stabilizers, other organic or inorganic additives, or a combination thereof.

The compositions prepared in the present disclosure can be used in formation of a resin blend, suitable as a “B-side component” of a pre-polymer composition. The resin blend may include the modified polyester and/or polyether polyol compositions prepared in the present disclosure and may further include other polyols, solvents, catalysts, chain extenders, cross-linkers, curing agents, surfactants, blowing agents, fillers, flame retardants, plasticizers, light stabilizers, colorants, waxes, biocides, minerals, micronutrients, inhibitors, stabilizers or other organic or inorganic additives.

The resin blend can be reacted with a polyfunctional isocyanate (“A-side component”), such as methylene diphenyl diisocyanate (MDI) or a polymeric MDI (PMDI). Reaction of the A-side and B-side components may provide new PUR and/or PIR polymers depending upon the specific conditions implemented.

Non-limiting examples of the A-side component can be Mondur® MR Lite from Bayer Corporation and Rubinate® M from Huntsman Corporation. The A-side component of the formulations of the present disclosure can be selected from organic polyisocyanates, modified polyisocyanates, isocyanate-based prepolymers, and mixtures thereof. Such choices can also include aliphatic and cycloaliphatic isocyanates, but aromatic and especially multifunctional aromatic isocyanates are particularly useful. The A-side component is not limited to those specifically illustrated herein.

The B-side component can be a resin blend containing one or more Mannich polyols, one or more polyester polyols, one or more polyether polyols, or a combination thereof. Additionally, the B-side component can contain catalysts, surfactants, flame retardants, and/or blowing agents. An example of Mannich polyol is Jeffol® R-425X available from Huntsman Corp. Non-limiting examples of aromatic polyester polyols are Terate® HT 5500, Terate® HT 5503, Terate® HT 2000, and the like, polyols, that are commercially available from INVISTA S.à r.l.

The compositions prepared in the present disclosure can further include one or more silicone copolymers for use with the blowing agents. An example can include commercially available NIAX silicone L series copolymers that is a registered Trademark of Momentive Performance Materials Inc.

The polyurethane (PUR) and/or polyisocyanurate (PIR) polymers of the present disclosure can be formed from a polyester or polyether polyol, a catalyst, a surfactant, and a blowing agent. The use of PUR and/or PIR polymers may include various amines or polyamines as chain extenders, cross-linkers, curing agents in coatings application. In other embodiments, the PUR and/or PIR polymers may be used for fiber-reinforced compositions, such as a wood fiber reinforced composite. In some other embodiments, the use of PUR and/or PIR polymers may provide a foam composition, formed by reacting polyol resin with organic isocyanates in the presence of a suitable blowing agent. The foam composition can be spray foam, wherein the polyol resin, organic isocyanates, are sprayed on a surface to allow the components to react to form the foam as the PUR and/or PIR polymers form in the presence of the blowing agent.

The isocyanate can include any isocyanate with an average functionality (e.g., number of functional groups that can react with other molecules to form a polymer) of at least 2 that can be used to make a suitable polyurethane (PUR) and/or polyisocyanurate (PIR) foam.

### Surfactants.

Surfactants, such as those used in the B-side component resin blend, can be any one or more suitable surfactants. The surfactant can include an organic surfactant, a silicone-based surfactant, or combinations thereof. The surfactant can serve to regulate the cell structure of the foam by helping to control the cell size in the foam and reducing the surface tension during foaming via reaction of the polyol (e.g., an aromatic polyesterpolyol (APP)) with the organic polyisocyanate.

Examples of suitable surfactants include silicone-polyoxyalkylene block copolymers, nonionic polyoxyalkylene glycols and their derivatives, and ionic organic salts thereof. Examples of suitable surfactants include polydimethylsiloxane-polyoxyalkylene block copolymers sold under the trade names Dabco™ DC-193 and Dabco™ DC-5315 (Air Products and Chemicals, Allentown, Pa.), or Tegostab B8871 (EVON IC) ether sulfates, fatty alcohol sulfates, sarcosinates, amine oxides, sulfonates, amides, sulfo-succinates, sulfonic acids, alkanol amides, ethoxylated fatty alcohol, nonionics such as polyalkoxylated sorbitan, or a combination thereof.

In an embodiment, the amount of surfactant in the composition can be about 0 wt % to 5 wt %, based on the total weight of the B-side or of the foam precursor.

### Blowing Agent

In an embodiment, the blowing agent can be made from any of the classes of blowing agents and systems used to make polyurethane and polyisocyanurate foams which are well known in the art: a hydrocarbon/water co-blown system; a HFC or HFC/water co-blown system; a HFO and/or HFO/water co-blown and/or HFO/water/hydrocarbon system; or a water blown system (also referred to in the art as a carbon dioxide-blown system since CO₂ is derived from the water-isocyanate reaction).

In an HFC- or HFO-blown system, a liquid blowing agent is added to a mixture of polyol, catalysts, and surfactants prior to adding a polyisocyanate. In the water-blown system, water is added and mixed with a polyol, catalyst, and surfactant mixture prior to adding a polyisocyanate. In the water and hydrocarbon co-blown system, both water and hydrocarbon blowing agents are added to a polyol, catalyst, and surfactant mixture prior to adding a polyisocyanate. During full-scale production, these components may be metered directly into the mixing head of the foam machine or can be premixed with a polyol stream prior to injecting into the mixing head.

A hydrogen atom-containing blowing agent can be employed to produce the foam compositions. These blowing agents, which can be used alone or as mixtures with other blowing agents, can be selected from a broad range of materials, including partially halogenated hydrocarbons, ethers and esters, hydrocarbons, esters, ethers, and the like. Hydrogen-containing blowing agents include the HCFCs such as 1,1-dichloro-1-fluoroethane, 1,1-dichloro-2,2,2-trifluoro-ethane, monochlorodifluoromethane, and 1-chloro-1,1-difluoroethane; the HFCs such as 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, and pentafluoroethane; and the HFEs such as methyl-1,1,1-trifluoroethylether and difluoromethyl-1,1,1-trifluoro-ethylether. Hydrocarbon blowing agents can include hydrocarbons such as n-pentane, isopentane, and cyclopentane.

Blowing agents containing predominately hydrocarbon compounds and only small amounts of fully halogenated hydrocarbons are desirable, for example ≤10 wt %, ≤5 wt % or ≤1 wt % fully halogenated hydrocarbons. For example, the blowing agents can be free of industrially detectable amounts of fully halogenated hydrocarbons.

In the case of foam applications, the PUR/PIR polymers, obtained according to the present disclosure, may be foamed by use of a blowing agent. A blowing agent is a volatile material that volatilizes and expands within the solidifying polymer composition, producing bubbles in the material, which are then present in the final foam structure containing the solid polymer reaction product. Foams can be adherent as well, depending on the nature of the object they contact, and can be used as insulation, packing, and the like. Or, the foam can be set up without adherence to external objects, producing solid foam blocks, sheets, packing peanuts, and the like.

The blowing agent can include a hydrocarbon having 3 to 7 carbon atoms, water, carbon dioxide, or combinations thereof. The hydrocarbon can include butane, n-pentane, iso-pentane, cyclopentane, hexane, cyclohexane, an alkene analogue thereof, a fluorinated analogue thereof, or a combination thereof.

The blowing agent can include two or more blowing agents (e.g., blowing agent, co-blowing agent, and the like). For example, the blowing agent can be pentane and the co-blowing agent can be water, where pentane can be about 60 to 99% by weight of the blowing agents and water can be about 1 to 40% by weight of the blowing agents.

Hydrofluoroolefin (HFO) blowing agents can also be used. Examples of HFO blowing agents are disclosed in U.S. Pat. Nos. 8,772,364, 8,648,123, 8,314,159, 9,029,430 and US20140316020. Examples of HFO blowing agents may contain 3, 4, 5, or 6 carbons, and include but are not limited to pentafluoropropenes, such as 1,2,3,3,3-pentafluoropropene (HFO-1225ye); tetrafluoropropenes, such as 1,3,3,3-tetrafluoropropene (HFO-1234ze), E and Z isomers), 2,3,3,3-tetrafluoropropene (HFO-1234yf), and 1,2,3,3-tetrafluoropropene (HFO-1234ye); trifluoropropenes, such as 3,3,3-trifluoropropene (HFO-1234zf); tetrafluorobutenes, such as (HFO-1234); pentafluorobutene isomers, such as (HFO-1354); hexafluorobutene isomers, such as (HFO-1336); heptafluorobutene isomers, such as (HFO-1327); heptafluoropentene isomers, such as (HFO-1447); octafluoropentene isomers, such as (HFO-1438); nonafluoropentene isomers, such as (HFO-1429); and hydrochloroolefins, such as 1-chloro-3,3,3-trifluoropropene (HCFO-1233zd) (E and Z isomers), 2-chloro-3,3,3-trifluoropropene (HCFO-1233x0, HCFO-1223, 1,2-dichloro-1,2-difluoroethene (E and Z isomers), 3,3-dichloro-3-fluoropropene, 2-chloro-1,1,1,4,4,4-hexafluorobutene-2(E and Z isomers), and 2-chloro-1,1,1,3,4,4,4-heptafluorobutene-2 (E and Z isomers). Preferred blowing agents in the thermosetting foam blends of the present disclosure include unsaturated halogenated hydroolefins with normal boiling points less than about 60° C. Preferred hydrochlorofluoroolefin and hydrofluoroolefin blowing agents include, but are not limited to, 1-chloro-3,3,3-trifluoropropene; E and/or Z HCFO-1233zd; 1,3,3,3-tetrafluoropropene; E and/or Z HFO-1234ze; and HFO-1336, both cis and trans isomers.

### EXAMPLES

Various embodiments of the present invention can be better understood by reference to the following Examples which are offered by way of illustration. The present invention is not limited to the Examples given herein.

The acid number (AN) or acid value (AV) determination is performed according to the ASTM D-4662 method. The acid number unit of measurement is mg KOH/g of sample.

The hydroxyl number (HN), OH # or hydroxyl value (HV) determination is performed according to the ASTM D-4274 method. The hydroxyl number unit of measurement is mg KOH/g of sample.

The water content in the sample is determined according to the ASTM D-4672 method. The water content is measured as wt % relative to the total sample weight.

The sample viscosity at 25° C. is determined according to the ASTM D-4878 method. The viscosity is measured in the units of centipoise (cps).

Foam properties are measured according to various standard test methods. K-factor is measured according to ASTM C518-04 Standard Test Method for Steady State Thermal Transmission Properties by Means of the Heat Flow Meter Apparatus. Aged K-Factor are based on foams stored at 70° C. for the specified time. Closed cell content is determined as 100% minus open cell content, which is measured according to ASTM D6226-05 Standard Test Method for Open Cell Content of Rigid Cellular Plastics. Humid age dimensional stability is measured according to ASTM D2126-04 Standard Test Method for Response of Rigid Cellular Plastics to Thermal and Humid Aging. Foam density is measured according to ASTM D1622-93 Standard Test Method for Apparent Density of Rigid Cellular Plastics. Compressive strength is measured according to ASTM D1621-94 Standard Test Method for Compressive Properties of Rigid Cellular Plastics. ASTM standard methods are from ASTM International, West Conshohocken, Pa., USA, www.astm.org.

The following terms are used in accordance with ASTM D7487-13 “Standard Practice for Polyurethane Raw Materials: Polyurethane Foam Cup Test.” “Cream Time” or “CT” is the time when bubbles start to make the level of liquid to rise. “Gel Time” or “GT” is the time when strings can no longer be pulled during the foaming reaction. “Tack Free Time” or “TFT” or “T.F” is the time when the foam is no longer tacky or sticky. The term “End of Rise” or “E.R.”, as used herein, is the time when the foam stops rising during the foaming process. The term “Isocyanate Index” or “INDEX”, as used herein, is the ratio of amount of isocyanate used to theoretical amount of isocyanate needed to react all available OH groups in a formulation. The term “K-Factor”, as used herein, is a measure of heat in British-thermal-units (BTUs) that passes through a 1-inch thick, 1-ft² of foam surface area in 1 hour, for each degree Fahrenheit (or ° F.) temperature interval. The term “R-Value”, as used herein, is the inverse of the K-factor and is a measure of thermal resistance for a particular material such as rigid foam. In the examples of the present disclosure the units of measurement for R-Value are ft².hr.° F./Btu.inch. The term “Lambda Value” or “λ Value”, as used herein, is the heat conductivity of a material. The lambda value is used for thermal calculations on buildings and thermal components. The thermal conductivity of a material is defined as the quantity of heat (e.g., Joules) transferred in a given time (e.g., seconds) through a distance L (e.g., meters) in a direction normal to a surface area A (e.g., sq. meter), due to a temperature difference ΔT (e.g., Kelvin), and when the heat transfer is dependent only on the temperature gradient. One commonly used unit of Lambda-value is Watts/m·K. One watt is one Joule/second. The lower a material's lambda [λ] value, the better its ability to insulate. In the examples of the present disclosure the units of measurement for Lambda are mW/meter·° C. the unit “mW” means miliWatts.

Foams in the present Examples are generated primarily via hand-mix preparations. Various foams are also generated from pilot laminators. Foam performance is monitored using procedures set forth in standard methods, namely, ASTM D-1622 for density measurements, ASTM C-518 for initial and aged K-factor data, ASTM D-2126 for dimensional stability, and ASTM D-1621 for compressive strength.

The polyols are characterized for acidity, hydroxyl values, and viscosities at 25° C. The total acid number (AN) and hydroxyl values (OH #) are determined by using the standard titration methods. Dynamic viscosity measurements are done at 25° C. on a Brookfield viscometer.

The term “Terate® HT 2000 Polyol”, as used herein, refers to an aromatic polyester polyol that is manufactured by INVISTA and commercially available under the brand name INVISTA Terate® HT 2000 polyol. The term “Terate® HT 2004 Polyol”, as used herein, refers to an aromatic polyester polyol that is manufactured by INVISTA and commercially available under the brand name INVISTA Terate® HT 2004 polyol. The term “Terate® HT 5500 Polyol”, as used herein, refers to an aromatic polyester polyol that is manufactured by INVISTA and commercially available under the brand name INVISTA Terate® HT 5500 polyol. The term “Terate® HT 5503 Polyol”, as used herein, refers to an aromatic polyester polyol that is manufactured by INVISTA and commercially available under the brand name INVISTA Terate® HT 5503 polyol.

Table C lists the product specifications of various Terate® polyol grades that are commercially available from INVISTA Intermediates and used in the present examples. Terate® polyol is a registered trademark of INVISTA. Other details are available at the INVISTA Polyols website: https://polyols.invista.com/products/Terate/product-infonnatiou/.

TABLE C
Product specifications of various Terate ® polyol grades.

| | Acid No. | Hydroxyl | Water | Viscosity |
|---|---|---|---|---|
| | mg | No. | Content, | at 25° C., |
| Polyol Grade | KOH/g | mg KOH/g | % | cps |
| Terate ® HT | ≤2.0 | 200-215 | ≤0.15 | 5000-8000 |
| 2000 | | | | |
| Terate ® HT | ≤1.9 | 185-200 | ≤0.15 | 3500-5000 |
| 2004 | | | | |
| Terate ® HT | ≤1.3 | 225-245 | ≤0.15 | 2500-5000 |
| 5500 | | | | |
| Terate ® HT | ≤1.3 | 225-245 | ≤0.15 | 2000-5000 |
| 5503 | | | | |

The term “TCPP”, as used herein, refers to tris(2-chloro-1-methylethyl) phosphate. The 95% (min.) concentration TCPP is available from Sigma-Aldrich, ICL Supresta, Albemarle, Shekoy, Cellchem and other commercial suppliers.

As used herein, the term “Total Catalyst” may include commercially available catalysts Polycat@ 46, Dabco® K-15, Polycat® 5 and such. These are a class of isocyanate trimerization catalysts that are known industrially.

### Examples 1(a-b). Addition of Azeotropic Additive Such as Methyl Formate to PIR System Blown with 50/50 Iso/n-Pentane

Table 1 shows Example 1(a) that is without the addition of methyl formate to the system compared Example 1(b) that includes the addition of methyl formate in the system. The system uses 50/50 iso/n-pentane as blowing agent. The polyol used in these examples was Terate® HT 5503 polyol having a hydroxyl value of 240 mg KOH/g sample.

TABLE 1
Examples 1(a-b).

| Example No. | 1(a) | 1(b) |
|---|---|---|
| Blowing agent | 50/50 iso/n | 50/50 iso/n |
| | pentane | pentane |
| Methyl Formate wt. % in total | — | 0.5% |

Component (wt. part)

| | | |
|---|---|---|
| Terate ® HT 5503 polyol | 100.0 | 100.0 |
| [OH # 240] | | |
| Polyol | 0.0 | 0.0 |
| Flame Retardant | 15.0 | 15.0 |
| Total catalyst | 7.4 | 7.4 |
| Water | 0.80 | 0.80 |
| Surfactant | 2.50 | 2.50 |
| Methyl formate | — | 2.0 |
| Blowing Agent | 25.0 | 22.7 |
| INDEX | 2.60 | 2.60 |

| | | | R-value |
|---|---|---|---|
| R-values of foil thickness board, ft² · hr · ° F./Btu · inch | | | difference |
| At 36.5° F. (2.5° C.) | 5.65 | 6.07 | 0.41 |
| At 56.1° F. (13.4° C.) | 6.19 | 6.44 | 0.25 |
| At 76.1° F. (24.5° C.) | 6.15 | 6.27 | 0.12 |

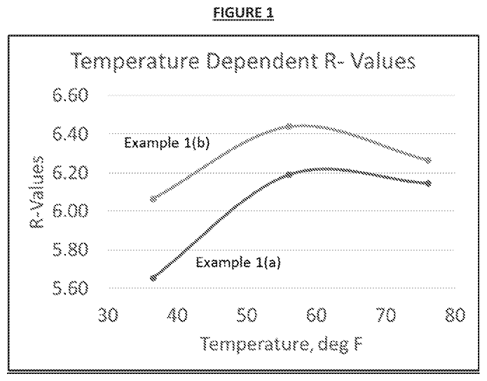

It is surprisingly found that the R-value of the full thickness board specimens is improved at all test temperatures, and especially, at low temperatures. At 36.5° F., the R-value improvement was 0.41, and at 56.1° F., the R-value improvement was 0.25. FIG. 1 is a graph representing the R-values for Examples 1(a-b).

### Examples 2(a-f). Low Temperature R-Values of Iso-Pentane/Cyclopentane Systems Versus Iso-Pentane System Containing <1% Azeotropic Additive

Table 2 shows PIR systems including iso-pentane, and including various amounts of cyclopentane, with methyl formate added in Example 2(c) at <1% level thereby replacing cyclopentane in the system. The polyol used in these examples is Terate® HT 2000 polyol having a hydroxyl value of 212 mg KOH/g. In Table 3, mechanical and dimensional properties of foams from PIR systems 2(a-f) are shown.

TABLE 2
Examples 2(a-f) compositions.

| | | | | | | |
|---|---|---|---|---|---|---|
| Example No. | 2(a) | 2(b) | 2(c) | 2(d) | 2(e) | 2(f) |

| | |
|---|---|
| wt. % TCPP | 4.2% |
| wt. % Catalyst | 1.10% |
| wt. % Surfactant | 0.50% |

Component (wt. part)

| | | | | | | |
|---|---|---|---|---|---|---|
| Terate ® HT 2000 | 100.0 | 100.0 | 100.0 | 100.0 | 100.0 | 100.0 |
| polyol [OH #212] | | | | | | |
| Flame Retardant | 15.0 | 15.0 | 15.0 | 15.0 | 15.0 | 15.0 |
| Total Catalyst | 3.91 | 3.91 | 3.91 | 3.91 | 3.91 | 3.91 |
| Surfactant | 2.50 | 2.50 | 2.50 | 2.50 | 2.50 | 2.50 |
| Water | 1.14 | 1.14 | 1.14 | 1.14 | 1.14 | 1.14 |
| Methyl Formate | — | — | 2.0 | — | — | — |
| Cyclopentane | 4.6 | 0.0 | 0.0 | 7.6 | 4.6 | 11.4 |
| Iso-pentane | 18.2 | 22.8 | 20.8 | 15.2 | 18.2 | 11.4 |
| INDEX | 2.90 | 2.90 | 2.90 | 2.90 | 2.90 | 2.90 |

TABLE 3
Examples 2(a-f). Mechanical and dimensional properties of foams.

| Example No. | 2(a) | 2(b) | 2(c) | 2(d) | 2(e) | 2(f) |
|---|---|---|---|---|---|---|
| Methyl Formate (% bv wt.) | — | — | 0.6% | — | — | — |
| wt. % Cyclopentane | 1.28% | — | — | 2.13% | 1.28% | 3.20% |
| wt. % Cyclopentane in total | 20% | — | — | 33% | 20% | 50% |
| hydrocarbon | | | | | | |
| Total pentane (% by wt.) | 6.38% | 6.39% | 5.83% | 6.39% | 6.38% | 6.39% |
| Foam Density | 1.66 | 1.65 | 1.64 | 1.64 | 1.64 | 1.58 |
| Reactivity Profiles, sec | | | | | | |
| Cream Time, CT | 7 | 6 | 6 | 7 | 7 | 7 |
| Gel Time, GT | 33 | 34 | 35 | 33 | 34 | 33 |
| Tack-Free Time, TFT | 49 | 49 | 54 | 51 | 49 | 51 |
| End of Rise, E.R | 52 | 52 | 52 | 52 | 54 | 52 |
| FREEZER, vol % change | | | | | | |
| 14 D | −2% | −2% | 0% | 0% | 1% | 0% |
| 28 D | −2% | −3% | −1% | −1% | −1% | −1% |
| HUMID AGE, vol % change | | | | | | |
| 14 D | 6% | 3% | 6% | 10% | 6% | 10% |
| 28 D | 6% | 5% | 6% | 9% | 6% | 9% |
| Compressive Strength, psi | | | | | | |
| Parallel | 38.4 | 37.7 | 37.1 | 38.0 | 37.9 | 38.0 |
| Perpendicular | 12.5 | 12.2 | 11.4 | 11.2 | 11.2 | 11.2 |
| Average | 25.5 | 25.0 | 24.2 | 24.6 | 24.5 | 24.6 |
| At Temperature, deg F. | R-Values-Initial, ft² · hr · ° F./Btu · inch | | | | | |
| 40.1 (4.5° C.) | 6.77 | 6.79 | 6.91 | 6.77 | 6.76 | 6.75 |
| 75.2 (24° C.) | 6.44 | 6.35 | 6.32 | 6.54 | 6.44 | 6.64 |
| At Temperature, deg F. | R-Values-Aged [after 8 weeks], ft² · hr · ° F./Btu · inch | | | | | |
| 36.5 (2.5° C.) | 6.24 | 6.27 | 6.41 | 6.26 | 6.26 | 6.26 |
| 54.5 (12.5° C.) | 6.40 | 6.44 | 6.45 | 6.44 | 6.43 | 6.43 |
| 76.1 (24.5° C.) | 6.19 | 6.16 | 6.09 | 6.27 | 6.21 | 6.33 |

The PIR system containing iso-pentane and <1% azeotropic additive, as in Example 2(c), exhibits higher R-values at 40° F. and below when compared to the PIR systems containing cyclo-pentane (Examples 2(d-f)). The same trend is observed on the foam after aging for 8 weeks.

### Examples 3(a-b′). The Use of Azeotropic Additive to Lower HFO Loading in the System

In Table 4, Example 3(a) uses a 50/50 cyclo-/iso-pentane HFO system without methyl formate addition and Example 3 (b) is with the addition of methyl formate at <1% loading. The polyol in these examples is Terate® H-T 2004 polyol having a hydroxyl value of 188 mg KOH/g.

TABLE 4
Examples 3(a-b).

| | Example 3(a) | Example 3(b) |
|---|---|---|
| Component (wt. part) | | |
| Terate ® HT 2004 Polyol [OH # 188] | 100.0 | 100.0 |
| Total catalyst | 3.4 | 3.4 |
| Flame retardant | 5.0 | 5.0 |
| Surfactant | 2.50 | 2.50 |
| HFO | 25.0 | 20.2 |
| Water | 1.05 | 1.05 |
| Methyl formate | — | 2.0 |
| 50/50 cyclo/iso-pentane | 6.0 | 6.0 |
| (Blowing Agent) | | |
| INDEX | 2.80 | 2.80 |
| wt. % HFO | 7.7% | 6.3% |
| wt. % Methyl formate | — | 0.6% |
| Foam Density, pcf | 1.88 | 1.75 |
| Foam Density, kg/m³ | 30.1 | 28.1 |
| Insulation Values | | |
| Initial, Lambda values in mW/m · ° C. | | |
| at 10° C. | 17.7 | 17.8 |
| at 24.5° C. | 19.3 | 19.5 |
| One-Month Aged lambda, mW/m · ° C. | | |
| at 2.5° C. | 18.1 | 18.1 |
| at 12.5° C. | 19.3 | 19.4 |
| at 24.5° C. | 20.8 | 20.9 |
| Initial, R-values in ft² · | | |
| hr · ° F./Btu · inch | | |
| at 10° C. | 8.16 | 8.09 |
| at 24.5° C. | 7.47 | 7.40 |
| One-Month Aged R-values in ft² · | | |
| hr · ° F./Btu · inch | | |
| at 2.5° C. | 7.96 | 7.96 |
| at 12.5° C. | 7.47 | 7.43 |
| at 24.5° C. | 6.92 | 6.89 |

It is surprisingly observed that equivalent insulations values are achieved at lower HFO loading in the presence of <1% levels of methyl formate in the system.

### Examples 4(a-b′). Use of Azeotropic Additives to Improve Low-Temperature R-Values on Low Water PIR Systems

In Table 5, Example 4(a) uses a n-pentane system without the addition of methyl formate, while Example 4(b) includes methyl formate addition at <1% loading in the system. The polyol used in these examples was Terate® HT 5500 polyol having a hydroxyl value of 238 mg KOH/g.

TABLE 5
Examples 4(a-b).

| | Example 4(a) | Example 4(b) |
|---|---|---|
| Component (wt. part) | | |
| Terate ® HT 5500 Polyol | 100.0 | 100.0 |
| [OH# 238] | | |
| Flame Retardant [TCPP] | 11.2 | 11.2 |
| Total Catalyst | 4.3 | 4.3 |
| Surfactant | 2.09 | 2.09 |
| Water | 0.35 | 0.35 |
| Methyl formate | — | 2.2 |
| n-pentane | 24.0 | 22.0 |
| INDEX | 2.50 | 2.50 |
| wt. % Methyl Formate | — | 0.71% |
| wt. % Catalyst | 1.40% | 1.39% |
| wt. % Water | 0.11% | 0.11% |
| Foam Density, pcf | 1.64 | 1.68 |
| Reactivity Profiles, sec | | |
| Cream Time, CT | 9.9 | 10.4 |
| Gel Time, GT | 26.3 | 26.7 |
| Tack-Free Time, TFT | 34.6 | 35.6 |
| End of Rise, E.R | 39.7 | 39.7 |

| | | |
|---|---|---|
| | R-value-Initial, | R-value |
| Temperature, deg F. | ft² · hr · ° F./Btu · inch | Difference |

| | | | | |
|---|---|---|---|---|
| 36.5 | (2.5° C.) | 5.35 | 5.95 | 0.60 |
| 40.1 | (4.5° C.) | 5.47 | 6.04 | 0.57 |
| 54.5 | (12.5° C.) | 5.97 | 6.36 | 0.39 |
| 72.5 | (22.5° C.) | 6.40 | 6.53 | 0.13 |

Often times, low water content C₅-based PIR formulations give diminished R-values at low temperatures. It is unexpectedly observed that for Example 4(b), the addition of azeotropic additives such as methyl formate provided improved R-values in the temperature range from 36.5° F. to 72.5° F., and especially, more so in the low temperatures, as compared to the system in Example 4(a) that is without methyl formate.

### Example 5. Use of Azeotropic Additive at <1% in the Foam to Improve Long Term Thermal Resistance (LTTR)

The LTTR-values of the foams developed from Examples 1(a) and 1(b) are listed in Table 6 below. The LTTR value is the estimate of the R-value and can be measured using ASTM C1303, S770-15 or equivalent method. Higher LTTR-values are observed in the PIR system containing <1% methyl formate in the foam 1(b) as compared to those for Example 1(a) without the methyl formate addition.

TABLE 6
LTTR-values for foams developed from Examples 1(a-b).

| LTTR-values | Example 1(a) | Example 1(b) |
|---|---|---|
| Initial | 6.71 | 6.82 |
| 4-inch thickness | 6.01 | 6.18 |
| 3-inch thickness | 5.88 | 6.06 |
| 2-inch thickness | 5.71 | 6.00 |

### Example 6. Use of Methanol as Azeotropic Additive in Foam Systems

Similar to the above-described Examples and using similar components, methanol is used as azeotrope-inducing additive to the HFO blowing agent system for foams. The foams developed with this system [See Table 7] show superior low-temperature R-values along with long-term thermal resistance (LTTR).

TABLE 7

| | Example | Example | Example | Example |
|---|---|---|---|---|
| | 6(a) | 6(b) | 6(c) | 6(d) |
| Component (wt. part) | | | | |
| Terate ® HT | 90.0 | 90.0 | 90.0 | 90.0 |
| 5510 Polyol | | | | |
| Flame Retardant | 10.0 | 10.0 | 10.0 | 10.0 |
| (TCPP) | | | | |
| Catalysts | 4.1 | 4.1 | 3.9 | 3.9 |
| Hfo (Solstice ® 1233zd) | 37.0 | 26.0 | 42.0 | 30.0 |
| H2O | 1.05 | 1.05 | 0.50 | 0.50 |
| Methanol | 0.0 | 2.5 | 0.0 | 2.5 |
| INDEX | 2.65 | 2.65 | 2.65 | 2.65 |
| % MeOH (by wt.) | — | 0.7% | — | 0.8% |
| Density, kg/m³ | 29.0 | 28.7 | 29.0 | 29.2 |

Initial Lambda values, mW/m ° C.

| | | | | |
|---|---|---|---|---|
| at 5° C. | 19.3 | 19.2 | 18.6 | 18.5 |
| at 24° C. | 21.1 | 21.0 | 20.4 | 20.3 |

6 months aged lambda values, mW/m ° C.

| | | | | |
|---|---|---|---|---|
| at 2.5° C. | 23.4 | 23.4 | 22.2 | 22.1 |
| at 12.5° C. | 24.7 | 24.6 | 23.4 | 23.2 |
| at 24.5° C. | 26.2 | 26.0 | 24.9 | 24.7 |

### Example 7—Use of Acetone as Azeotropic Additive in Foam Systems

Similar to the above described examples and using similar components, acetone is used as azeotrope inducing additive to the C₅ hydrocarbon blowing agent system for foams. The foams developed with this system [see Table 8] show superior low-temperature R-values along with long-term thermal resistance [LTTR].

TABLE 8

| | Example 7(a) | Example 7(b) | Example 7(c) | Example 7(d) |
|---|---|---|---|---|
| Hydrocarbon [Blowing Agent] | 50/50 iso:n-pentane | | Isopentane | |
| % Acetone (by wt.) | 0.0% | 0.5% | 0.0% | 0.5% |

Component (wt. part)

| | | | | |
|---|---|---|---|---|
| POLY1 | 100.0 | 100.0 | 100.0 | 100.0 |
| Acetone | 0.0 | 1.5 | 0.0 | 1.5 |
| Catalysts | 3.9 | 3.9 | 3.9 | 3.9 |
| Flame Retardant (TCPP) | 13.0 | 13.0 | 13.0 | 13.0 |
| Surfactant | 2.02 | 2.02 | 2.02 | 2.02 |
| H2O | 0.40 | 0.40 | 0.40 | 0.40 |
| Hydrocarbon | 24.0 | 22.0 | 24.0 | 22.0 |
| INDEX | 2.40 | 2.40 | 2.40 | 2.40 |
| Foam Density, pcf | 1.68 | 1.64 | 1.69 | 1.64 |
| Foam Density, kg/m³ | 27.0 | 26.3 | 27.1 | 26.3 |
| Reactivity Profiles, seconds | | | | |
| CREAM | 15 | 13 | 9 | 11 |
| GEL | 35 | 34 | 35 | 35 |
| T.F. | 49 | 44 | 49 | 45 |
| E.R. | 78 | 55 | 55 | 54 |
| Initial R values, | | | | |
| ft2 · hr · oF./Btu · inch | | | | |
| at 40° F. | 5.12 | 5.81 | 6.61 | 5.98 |
| at 75° F. | 6.00 | 6.31 | 6.27 | 6.35 |
| Initial lambda values, mW/m ° C. | | | | |
| at 5° C. | 28.2 | 24.8 | 28.1 | 24.1 |
| at 24° C. | 24.0 | 22.9 | 23.0 | 22.7 |

### Example 8. Use of Methylal as Azeotropic Additive in Foam Systems

Similar to the above-described Examples and using similar components, methylal is used as azeotrope-inducing additive to the C₅-hydrocarbon and HFo blowing agent system for foams. The foams developed with this system show superior low-temperature R-values along with long-term thermal resistance (LTTR).

### Example 9. Use of Methyl Formate Azeotropic Additive in Spray Foam Systems

Similar to the above-described Examples and using similar components, methyl formate is used as azeotrope-inducing additive to the Hfo blowing agent for spray foam systems. The spray foams developed with this system show superior low-temperature R-values along with long-term thermal resistance (LTTR).

### Example 10. Use of Methanol Azeotropic Additive in Spray Foam Systems

Similar to the above-described Examples and using similar components, methanol is used as azeotrope-inducing additive to the C₅-hydrocarbon blowing agent for spray foam systems. The spray foams developed with this system show superior low-temperature R-values along with long-term thermal resistance (LTTR).

### Example 11—Use of Acetone Azeotropic Additive in Spray Foam Systems

Similar to the above described examples and using similar components, methylal is used as azeotrope inducing additive to the C₅ hydrocarbon blowing agent for spray foam systems. The spray foams developed with this system show superior low-temperature R-values along with long-term thermal resistance [LTTR].

### Example 12. Use of Methylal Azeotropic Additive in Spray Foam Systems

Similar to the above-described Examples and using similar components, methylal is used as azeotrope-inducing additive to the C₅-hydrocarbon blowing agent for spray foam systems. The spray foams developed with this system show superior low-temperature R-values along with long-term thermal resistance (LTTR).

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Exemplary Embodiments

The following exemplary embodiments are provided, the numbering of which is not to be construed as designating levels of importance:

Embodiment 1 provides a blowing agent composition for a foam precursor, wherein the foam precursor forms a foam composition, the blowing agent composition comprising:

a blowing agent that is 80 wt % to 95 wt % of the blowing agent composition; and

one or more azeotropic-modifiers that lower the boiling point of the blowing agent composition, wherein the one or more azeotropic-modifiers are 5 wt % to 20 wt % of the blowing agent composition.

Embodiment 2 provides the blowing agent composition of Embodiment 1, wherein the blowing agent comprises a C₃-C₆ hydrocarbon, a hydrofluorocarbon (HFC), a hydrofluoroolefin (HFO), or a combination thereof.

Embodiment 3 provides the blowing agent composition of any one of Embodiments 1-2, wherein the blowing agent comprises one or more C₅-hydrocarbons, C₅-hydrofluorocarbons, or a combination thereof.

Embodiment 4 provides the blowing agent composition of any one of Embodiments 1-3, wherein the blowing agent comprises pentane.

Embodiment 5 provides the blowing agent composition of any one of Embodiments 1-4, further comprising water as a co-blowing agent.

Embodiment 6 provides the blowing agent composition of Embodiment 5, wherein the water is 0.1 wt % to 10 wt % of the blowing agent composition.

Embodiment 7 provides the blowing agent composition of Embodiment 5, wherein the water is 1 wt % to 6 wt % of the blowing agent composition.

Embodiment 8 provides the blowing agent composition of any one of Embodiments 1-7, wherein the blowing agent composition is free of components other than the blowing agent and the one or more azeotropic modifiers.

Embodiment 9 provides the blowing agent composition of any one of Embodiments 1-8, wherein the azeotropic-modifier is a C₁-C₅ alkane, a C₁-C₅ alcohol, a C₁-C₅ alkyl ester, a C₁-C₅ alkyl aldehyde, or a combination thereof.

Embodiment 10 provides the blowing agent composition of any one of Embodiments 1-9, wherein the azeotropic-modifier is methanol, methylal, ethanol, methyl formate, or a combination thereof.

Embodiment 11 provides the blowing agent composition of any one of Embodiments 1-10, wherein the azeotropic-modifier is methyl formate.

Embodiment 12 provides the blowing agent composition of any one of Embodiments 1-11, wherein the one or more azeotropic-modifiers are 6 wt % to 12 wt % of the blowing agent composition.

Embodiment 13 provides the blowing agent composition of any one of Embodiments 1-12, wherein the one or more azeotropic-modifiers are 8 wt % to 10 wt % of the blowing agent composition.

Embodiment 14 provides a B-side of a foam precursor comprising an A-side and the B-side, wherein the foam precursor forms a foam composition, the B-side of the foam precursor comprising:

the blowing agent composition of any one of Embodiments 1-12, wherein the blowing agent composition is optionally about 1 wt % to 30 wt % of the B-side (e.g., 5 to 20 wt %, 6 to 19 wt %, or 16 to 19 wt %);

polyol for reacting with one or more organic isocyanates comprised in the A-side to form the foam precursor;

catalyst for catalyzing the formation of the foam composition from the foam precursor; and

surfactant.

Embodiment 15 provides the B-side of Embodiment 14, wherein the one or more azeotropic-modifiers are 0.5 wt % to 3 wt % of the B-side.

Embodiment 16 provides the B-side of Embodiment 14, wherein the one or more azeotropic-modifiers are 1.2 wt % to 1.6 wt % of the B-side.

Embodiment 17 provides the B-side of any one of Embodiments 14-16, wherein the polyol comprises a polyester polyol, a polyether polyol, a copolymer thereof, or a combination thereof.

Embodiment 18 provides the B-side of any one of Embodiments 14-17, wherein the polyol comprises a polyester polyol.

Embodiment 19 provides the B-side of any one of Embodiments 14-18, wherein the polyol comprises an aromatic polyester polyol.

Embodiment 20 provides the B-side of any one of Embodiments 14-19, wherein the polyol has an acid number of 1 to 2.5 mg KOH/g.

Embodiment 21 provides the B-side of any one of Embodiments 14-20, wherein the polyol has an acid number of 1.3 to 2.0 mg KOH/g.

Embodiment 22 provides the B-side of any one of Embodiments 14-21, wherein the polyol has a hydroxyl number of 150 to 275 mg KOH/g.

Embodiment 23 provides the B-side of any one of Embodiments 14-22, wherein the polyol has a hydroxyl number of 185 to 245 mg KOH/g.

Embodiment 24 provides the B-side of any one of Embodiments 14-23, wherein the polyol has a viscosity at 25° C. of 1,000 to 10,000 cps.

Embodiment 25 provides the B-side of any one of Embodiments 14-24, wherein the polyol has a viscosity at 25° C. of 2,000 to 8,000 cps.

Embodiment 26 provides the B-side of any one of Embodiments 14-25, wherein the polyol is 50 wt % to 90 wt % of the B-side.

Embodiment 27 provides the B-side of any one of Embodiments 14-26, wherein the polyol is 65 wt % to 75 wt % of the B-side.

Embodiment 28 provides the B-side of any one of Embodiments 14-27, wherein the catalyst is an isocyanate trimerization catalyst.

Embodiment 29 provides the B-side of any one of Embodiments 14-28, wherein the catalyst is 0.001 wt % to 5 wt % of the B-side.

Embodiment 30 provides the B-side of any one of Embodiments 14-29, wherein the surfactant is 0.001 wt % to 5 wt % of the B-side.

Embodiment 31 provides a foam precursor that forms a foam composition, the foam precursor comprising:

an A-side comprising one or more organic isocyanates; and the B-side of any one of Embodiments 14-29, wherein the one or more azeotropic-modifiers are less than 1 wt % of the foam composition.

Embodiment 32 provides the foam precursor of Embodiment 31, wherein the one or more azeotropic-modifiers are in a range of greater than or equal to 0.001 wt % to less than 1 wt % of the foam composition.

Embodiment 33 provides the foam precursor of Embodiment 31, wherein the one or more azeotropic-modifiers are 0.5 wt % to 0.8 wt % of the foam composition.

Embodiment 34 provides the foam precursor of Embodiment 31, wherein the one or more azeotropic-modifiers are 0.6 wt % to 0.75 wt % of the foam composition.

Embodiment 35 provides the foam precursor of any one of Embodiments 31-34, wherein water is less than or equal to 0.15 wt % of the foam composition.

Embodiment 36 provides the foam precursor of any one of Embodiments 31-34, wherein water is 0.05 wt % to 0.15 wt % of the foam composition.

Embodiment 37 provides the foam precursor of any one of Embodiments 31-36, wherein the foam precursor has an isocyanate index of 1 to 4.

Embodiment 38 provides the foam precursor of any one of Embodiments 31-36, wherein the foam precursor has an isocyanate index of 2.4 to 3.

Embodiment 39 provides a foam composition formed from the foam precursor of any one of Embodiments 31-38.

Embodiment 40 provides the foam composition of Embodiment 39, wherein the foam composition is a rigid foam.

Embodiment 41 provides the foam composition of any one of Embodiments 39-40, wherein the foam composition has a foam density of greater than or equal to 1.5 lb/ft³ (24.03 kg/m³).

Embodiment 42 provides the foam composition of any one of Embodiments 39-41, wherein the foam composition has an insulation R-value of greater than 6 ft².hr.° F./Btu.inch.

Embodiment 43 provides the foam composition of any one of Embodiments 39-42, wherein the foam composition has an R-value at 40° F. (4.44° C.) of equal to or greater than an R-value at 75° F. (23.89° C.).

Embodiment 44 provides the foam composition of any one of Embodiments 39-43, wherein the foam composition has an improved R-value as compared to a corresponding foam composition that is free of the one or more azeotropic-modifiers.

Embodiment 45 provides the foam composition of any one of Embodiments 39-44, wherein the foam composition has an R-value that is 0.2 to 0.8 ft².hr.° F./Btu.inch higher at 36.5° C. as compared to a corresponding foam composition that is free of the one or more azeotropic-modifiers.

Embodiment 46 provides the foam composition of any one of Embodiments 39-45, wherein the foam composition has an R-value that is 0.4 to 0.6 ft².hr.° F./Btu.inch higher at 36.5° C. as compared to a corresponding foam composition that is free of the one or more azeotropic-modifiers.

Embodiment 47 provides the foam composition of any one of Embodiments 39-46, wherein the foam composition has an R-value of 5.9 to 7.5 ft².hr.° F./Btu.inch at 36.5° C. (e.g., equal to or greater than 5.9, or less than, equal to, or greater than 6.0, 6.1, 6.2, 6.3, 6.4, 6.5, 6.6, 6.7, 6.8, 6.9, 7, 7.1, 7.2, 7.3, 7.4, or equal to or less than 7.5).

Embodiment 48 provides the foam composition of any one of Embodiments 39-47, wherein the foam composition has an improved foam density as compared to a corresponding foam composition that is free of the one or more azeotropic-modifiers.

Embodiment 49 provides the foam composition of any one of Embodiments 39-48, wherein the foam composition has improved long-term thermal resistance as compared to a corresponding foam composition that is free of the one or more azeotropic-modifiers.

Embodiment 50 provides the foam composition of any one of Embodiments 39-49, wherein the foam composition has a long-term thermal resistance that is 0.01 to 0.5 ft².hr.° F./Btu.inch higher as compared to a corresponding foam composition that is free of the one or more azeotropic-modifiers.

Embodiment 51 provides the foam composition of any one of Embodiments 39-50, wherein the foam composition has a long-term thermal resistance that is 0.1 to 0.3 ft².hr.° F./Btu.inch higher as compared to a corresponding foam composition that is free of the one or more azeotropic-modifiers.

Embodiment 52 provides the foam composition of any one of Embodiments 39-51, wherein the foam composition has a long-term thermal resistance that is 6 to 7 ft².hr.° F./Btu.inch (e.g., equal to or greater than 6.0, or less than, equal to, or greater than 6.1, 6.2, 6.3, 6.4, 6.5, 6.6, 6.7, 6.8, 6.9, or equal to or less than 7.0).

Embodiment 53 provides a method of forming a foam composition, the method comprising:

reacting the foam precursor of any one of Embodiments 31-38 to form the foam composition.

Embodiment 54 provides the method of Embodiment 53, further comprising spraying the foam precursor.

Embodiment 55 provides the method of Embodiment 53-54, further comprising forming the foam precursor.

Embodiment 56 provides the method of Embodiment 55, wherein forming the foam precursor comprises combining the A-side and the B-side.

Embodiment 57 provides the method of any one of Embodiments 55-56, wherein forming the foam precursor comprises adding the one or more azeotropic-modifiers to a composition.

Embodiment 58 provides the blowing agent composition, the B-side of a foam precursor, the foam precursor, the form composition, or the method of forming the foam composition of any one or any combination of Embodiments 1-57 optionally configured such that all elements or options recited are available to use or select from.

1-20. (canceled)

21. A foam composition formed from a foam precursor, the foam precursor comprising:
(a) an A-side comprising at least one organic isocyanate; and
(b) a B-side comprising:
(1) a blowing agent composition comprising:
(A) 80 to 95 wt. %, based on the total weight of the blowing agent composition, of at least one blowing agent selected from hydrofluorocarbons, hydrofluoroolefins, hydrochlorofluorocarbons, hydrofluoroethers, n-pentane, isopentane, and cyclopentane; and
(B) 5 to 20 wt %, based on the total weight of the blowing agent composition, of at least one azeotropic-modifier selected from methanol, ethanol, isopropanol, ethyl formate, methyl formate, diethyl ether, methyl propyl ether, methylal, acetone, and acetonitrile;
(2) a polyol for reacting with the at least one organic isocyanate;
(3) a catalyst for catalyzing the formation of the foam composition from the foam precursor;
(4) a flame retardant; and
(5) a surfactant;
wherein the foam composition comprises less than 1 wt. % of the azeotropic-modifier.

22. The foam composition of claim 21 further comprising 0.1 to 10 wt. %, based on the amount of blowing agent composition, of water.

23. The foam composition of claim 21 wherein the blowing agent is selected from at least one of n-pentane, isopentane, and cyclopentane, and the azeotropic-modifier is selected from at least one of methanol, ethanol, isopropanol, ethyl formate, methyl formate, diethyl ether, methyl propyl ether, methylal, acetone, and acetonitrile.

24. The foam composition of claim 21 wherein the blowing agent is selected from at least one of n-pentane, isopentane, and cyclopentane, and the azeotropic-modifier is selected from at least one of methanol, ethanol, methylal, and methyl formate.

25. The foam composition of claim 21 wherein the blowing agent is selected from at least one of n-pentane, isopentane, and cyclopentane, and the azeotropic-modifier is methyl formate.

26. The foam composition of claim 21 wherein the blowing agent is selected from at least one of hydrofluorocarbons, hydrofluoroolefins, hydrochlorofluorocarbons, and hydrofluoroethers, and the azeotropic-modifier is selected from at least one of methanol, ethanol, isopropanol, ethyl formate, methyl formate, diethyl ether, methyl propyl ether, methylal, acetone, and acetonitrile.

27. The foam composition of claim 21 wherein the blowing agent is selected from at least one of hydrofluorocarbons, hydrofluoroolefins, hydrochlorofluorocarbons, and hydrofluoroethers, and the azeotropic-modifier is selected from at least one of methanol, ethanol, methylal, and methyl formate.

28. The foam composition of claim 21 wherein the at least one azeotropic-modifier is 0.5 to 3 wt. % of the B-side.

29. The foam composition of claim 21 wherein the polyol is an aromatic polyester polyol.

30. The foam composition of claim 21 wherein the foam composition is a rigid foam having a density of at least 1.5 lb./ft.³.

31. The foam composition of claim 30 having an R-value measured according to ASTM C518 at less than 4.5° C. greater than that of a corresponding foam composition that is free of the at least one azeotropic-modifier.

32. The foam composition of claim 30 having an R-value measured according to ASTM C518 at less than 4.5° C. of greater than 6 ft².hr.° F./Btu.inch.
